(19) United States
(12) Patent Application Publication
(10) Pub. No.: US 2026/0134450 A1
(43) Pub. Date: May 14, 2026

(54) NON-TRANSITORY COMPUTER READABLE STORAGE MEDIUM, CONTROL METHOD, AND TERMINAL APPARATUS

(71) Applicant: LY Corporation, Tokyo (JP)

(72) Inventors: Kazuhiro NINOMIYA, Tokyo (JP); Reiya YAMAGUCHI, Tokyo (JP)

(21) Appl. No.: 19/294,894

(22) Filed: Aug. 8, 2025

(30) Foreign Application Priority Data
Nov. 14, 2024 (JP) 2024-199251

(51) Int. Cl. G06Q 30/0251

(52) U.S. Cl. CPC G06Q 30/0251

(57) ABSTRACT

A terminal apparatus according to the present disclosure includes an acquisition unit that acquires input information that is input to a predetermined generation model by a user, an identification unit that identifies, based on the input information, product information that is estimated to be selected by the user, a generation unit that generates advertisement content information that indicates an advertisement content based on the identified product information, and a generation unit that generates advertisement content information that indicates an advertisement content based on the identified product information.

### CROSS-REFERENCE TO RELATED APPLICATIONS

The present application claims priority to and incorporates by reference the entire contents of Japanese Patent Application No. 2024-199251 filed in Japan on Nov. 1, 2024.

### BACKGROUND OF THE INVENTION

### 1. Field of the Invention

The present invention relates to a non-transitory computer readable storage medium having stored therein a control program, a control method, and a terminal apparatus.

### 2. Description of the Related Art

Conventionally, a technology for providing, together with a search result, an advertisement that is linked to a search query input by a user is known.

Patent Literature 1: Japanese Laid-open Patent Publication No. 2017-194845

However, in the conventional technology, an advertisement is distributed on condition that a user inputs a search query in a search service, and therefore, there is room for improvement in efficiently distributing an advertisement.

### SUMMARY OF THE INVENTION

A terminal apparatus according to the present disclosure includes an acquisition unit that acquires input information that is input to a predetermined generation model by a user, an identification unit that identifies, based on the input information, product information that is estimated to be selected by the user, a generation unit that generates advertisement content information that indicates an advertisement content based on the identified product information, and a generation unit that generates advertisement content information that indicates an advertisement content based on the identified product information.

### BRIEF DESCRIPTION OF THE DRAWINGS

FIG. 1 is a diagram illustrating a process that is performed by a terminal apparatus according to one embodiment;

FIG. 2 is a block diagram illustrating a configuration example of an information processing system according to one embodiment;

FIG. 3 is a diagram illustrating a configuration example of an information processing apparatus according to one embodiment;

FIG. 4 is a diagram illustrating an example of user information;

FIG. 5 is a diagram illustrating an example of advertisement information;

FIG. 6 is a diagram illustrating a configuration example of a user terminal according to one embodiment;

FIG. 7 is a flowchart illustrating the flow of a process that is performed by the user terminal according to one embodiment; and

FIG. 8 is a diagram illustrating an example of a hardware configuration.

### DETAILED DESCRIPTION OF THE PREFERRED EMBODIMENTS

Modes (hereinafter, described as “embodiments”) for carrying out a control program, a control method, and a terminal apparatus according to the present application will be described in detail below with reference to the drawings. Meanwhile, the control program, the control method, and the terminal apparatus according to the present application are not limited by the embodiments below. In addition, in each of the embodiments described below, the same components are denoted by the same reference symbols, and repeated explanation will be omitted.

### Embodiment

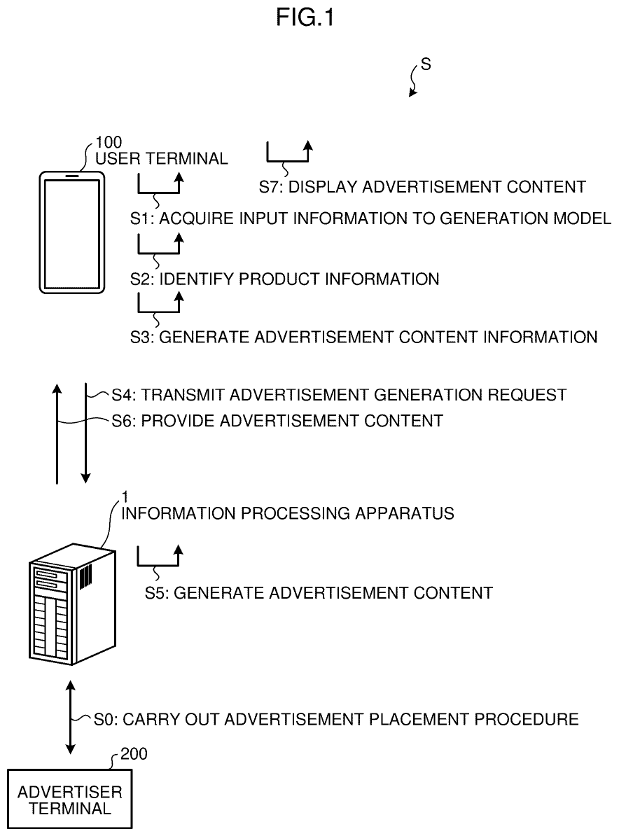

A process that is performed by a terminal apparatus according to one embodiment will be described below with reference to FIG. 1. FIG. 1 is a diagram illustrating a process that is performed by the terminal apparatus according to one embodiment. Meanwhile, FIG. 1 illustrates an example of operation of an information processing system S that includes a terminal apparatus (a user terminal 100) according to one embodiment.

As illustrated in FIG. 1, the information processing system S according to one embodiment includes an information processing apparatus 1, the user terminal 100, and an advertiser terminal 200.

As illustrated in FIG. 1, the information processing system S according to one embodiment acquires input information that is input to a predetermined generation model by a user, identifies, based on the input information, product information that is estimated to be selected by the user, generates advertisement content information that indicates an advertisement content based on the identified product information, transmits an advertisement generation request including the advertisement content information to the information processing apparatus 1, acquires, from the information processing apparatus 1, an advertisement content based on the advertisement content information, and displays the advertisement content on the user terminal 100.

Specifically, firstly, the information processing apparatus 1 and the advertiser terminal 200 carry out an advertisement placement procedure (Step S0). Specifically, firstly, the information processing apparatus 1 receives an advertisement distribution request from the advertiser terminal 200. The distribution request includes, for example, information on an advertising target product, an advertisement content (release of a new product, a sale to be held, or the like), a distribution target, an advertising budget, or the like.

The information processing apparatus 1, when receiving the distribution request, vectorizes a main intention of the advertisement based on information that is included in the distribution request. For vectorization, for example, a well-known vectorization method, such as Word to Vector, is used. Further, the information processing apparatus 1 determines an advertisement content, such as a situation in which the advertisement is published (a condition for a search query or the like) or a circumstance (a location of an advertisement area to be displayed or the like) based on the generated vector, and generates the advertisement based on the determined advertisement content. Furthermore, the information processing apparatus 1 transmits the generated advertisement to the advertiser terminal 200, and makes a request to an advertiser for permission to publish the advertisement. When the advertiser performs operation indicating permission to publish the generated advertisement, the advertiser terminal 200 transmits information on permission for placement and terminates the advertisement placement procedure. In contrast, when the advertiser performs operation indicating denial of permission to publish the generated advertisement, the advertiser terminal 200 makes a request to the information processing apparatus 1 for re-generation of an advertisement. When receiving a request for re-generation of an advertisement, the information processing apparatus 1 acquires information on a portion to be modified, performs vectorization again, and re-generates an advertisement.

Subsequently, the user terminal 100 acquires input information to a predetermined generation model (Step S1). For example, the generation model acquires, as the input information, a prompt (that is, a search query) for a generation model that generates a search result. Meanwhile, the generation model is not limited to the generation model that generates a search result, but may be an arbitrary generation model. Further, the input information may be information of various kinds of forms, such as a text, an image, or a voice.

Subsequently, the user terminal 100 identifies, based on the input information, product information that is estimated to be selected by the user (Step S2). The user terminal 100 stores therein a model (agent) that is trained to output product information from the input information. The model is a model that is trained with, for example, past input information and a behavior (a behavior of selecting a product or the like) that was made by the user after input of the input information. For example, the user terminal 100 generates a model that is trained with a behavior of leading to conversion with respect to an advertisement displayed in a search result screen, a behavior of browsing product information displayed in the search result screen, and a behavior of purchasing a product, which were made when the user inputted a predetermined search query in the past. In other words, the user terminal 100 inputs the input information to the model and identifies the product information that is estimated to be selected by the user based on a behavior (a behavior of selecting a product) that is output from the model. The product information includes, for example, a name, a type, a price, a function, or the like of a product.

Further, when identifying the product information, the user terminal 100 may additionally take into account the user information. In other words, the user terminal 100 identifies the product information based on the input information and the user information. For example, the user information includes an action history of the user, and the user terminal 100 identifies the product information based on the input information and the action history of the user. For example, the action history includes a browsing history on a network, and when the user recently viewed a site related to specific product information and when the input information and the specific product information are related to each other, the user terminal 100 adopts the specific product information as an identification result.

Subsequently, the user terminal 100 generates advertisement content information that indicates an advertisement content based on the identified product information (Step S3). For example, when the product information includes a name of a product, the user terminal 100 generates the advertisement content information with the advertisement content including the name of the product. Further, for example, when the product information includes a function of a product (for example, an air cleaning function), the user terminal 100 generates the advertisement content information with the advertisement content including the function.

Then, the user terminal 100 transmits an advertisement generation request that includes the generated advertisement content information to the information processing apparatus 1 (Step S4).

Subsequently, the information processing apparatus 1 generates an advertisement content based on the advertisement generation request (Step S5), and provides the advertisement content to the user terminal 100 (Step S6). Specifically, at Step S0 in the advertisement placement procedure, the information processing apparatus 1 selects an advertisement in which the advertisement content included in the advertisement generation request is adopted as a selling point, and generates the advertisement as the advertisement content. When a plurality of advertisements are selected, the information processing apparatus 1 generates, as the advertisement content, an advertisement for which an advertising cost per unit is highest based on a bidding system.

Then, the user terminal 100 displays the advertisement content (Step S7). The user terminal 100 displays the advertisement content that is acquired from the information processing apparatus 1 and an output result of the generation model with respect to the input information.

As described above, according to the user terminal 100 of the present disclosure, the product information is identified from the input information of the generation model that is irrelevant with advertisement distribution, and the advertisement content based on the product information is acquired and displayed from the information processing apparatus 1, so that it is possible to efficiently distribute the advertisement.

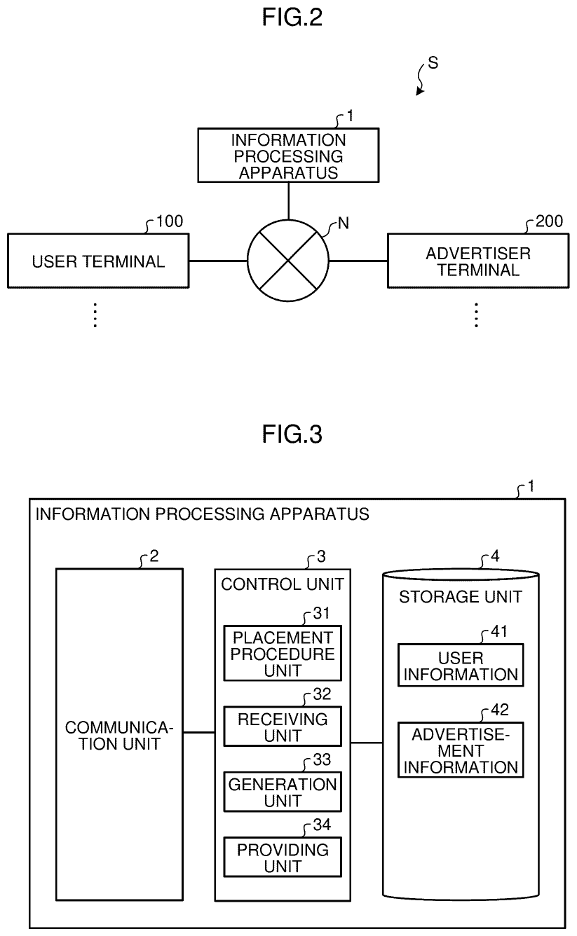

A configuration example of the information processing system S according to one embodiment will be described below with reference to FIG. 2. FIG. 2 is a block diagram illustrating a configuration example of the information processing system S according to one embodiment. As illustrated in FIG. 2, the information processing system S according to one embodiment includes the information processing apparatus 1, the plurality of user terminals 100, and the plurality of advertiser terminals 200 that are connected to each other in a wired or wireless manner via the network N. The network N is, for example, a certain network, such as the Internet, a Wide Area Network (WAN), or a Local Area Network (LAN).

The information processing apparatus 1 is a server apparatus that implements an information processing method according to one embodiment. The information processing apparatus 1 generates an advertisement content based on an advertisement generation request that is transmitted from the user terminal 100, and provides the advertisement content to the user terminal 100.

Furthermore, the information processing apparatus 1 is an information processing apparatus that cooperates with the plurality of user terminals 100 and the plurality of advertiser terminals 200 and provides an Application Programming Interface (API) service or the like for various kinds of applications (hereinafter, referred to as applications) and various kinds of data to the plurality of user terminals 100 and the plurality of advertiser terminals 200, and is implemented by a server apparatus, a cloud system, or the like.

Moreover, the information processing apparatus 1 may be an information processing apparatus that provides a certain Web service online to the plurality of user terminals 100 and the plurality of advertiser terminals 200. For example, the information processing apparatus 1 may provide, as the Web service, an Internet connection, a search service, a Social Networking Service (SNS), an Electronic Commerce (EC), an electronic payment, an online game, an online banking, an accommodation and ticket reservation, video and music distribution, news, a map, a route search, a route guide, route information, service status information, weather information, or the like. In reality, the information processing apparatus 1 may cooperate with various kinds of servers that provide Web services as described above, and mediate the Web services or handle processes of the Web services.

The user terminal 100 is a terminal apparatus that is carried by the user. As the user terminal 100, an arbitrary type of terminal apparatus, such as a smartphone, a desktop personal computer (PC), a notebook PC, or a tablet PC, may be used. The user terminal 100 transmits various kinds of information to the information processing apparatus 1 or the like, and receives information that is provided from the information processing apparatus 1 or the like. The user terminal 100 acquires input information that is input to a predetermined generation model by the user, identifies, based on the input information, product information that is estimated to be selected by the user, generates advertisement content information that indicates an advertisement content based on the identified product information, transmits an advertisement generation request including the advertisement content information to the information processing apparatus 1, acquires, from the information processing apparatus 1, an advertisement content based on the advertisement content information, and displays the advertisement content.

A configuration example of the information processing apparatus 1 will be described below with reference to FIG. 3.

FIG. 3 is a diagram illustrating a configuration example the information processing apparatus 1 according to one embodiment. As illustrated in FIG. 3, the information processing apparatus 1 includes a communication unit 2, a control unit 3, and a storage unit 4. The control unit 3 includes a placement procedure unit 31, a receiving unit 32, a generation unit 33, and a providing unit 34. The storage unit 4 stores therein user information 41 and advertisement information 42.

The communication unit 2 is implemented by, for example, a Network Interface Card (NIC) or the like. The communication unit 2 is connected to a network in a wired or wireless manner.

The control unit 3 is a controller and implemented by causing a processor, such as a Central Processing Unit (CPU) or a Micro Processing Unit (MPU), to execute various kinds of programs (corresponding to an example of the information processing program) that are stored in a storage device inside the information processing apparatus 1 by using a Random Access Memory (RAM) or the like as a work area. Further, the control unit 3 is a controller and may be implemented by, for example, an integrated circuit, such as an Application Specific Integrated Circuit (ASIC), a Field Programmable Gate Array (FPGA), or a General Purpose Graphic Processing Unit (GPGPU).

The storage unit 4 is implemented by, for example, a semiconductor memory device, such as a RAM or a Flash Memory, or a storage device, such as a hard disk or an optical disk.

The user information 41 is information on a user.

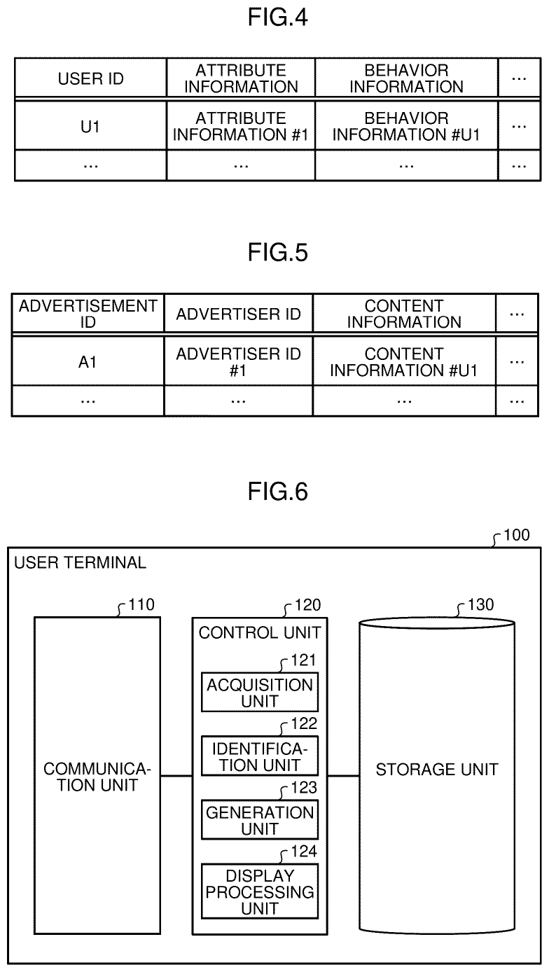

FIG. 4 is a diagram illustrating an example of the user information 41. As illustrated in FIG. 4, the user information 41 includes items such as a “user ID”,

The “user ID” is identification information for identifying a user. The “attribute information” is information on an attribute of the user. Examples of the attribute information include a psychographic attribute and a demographic attribute. The “behavior information” is information on a history of a behavior of the user, and includes a search behavior, a purchase behavior, a visit behavior, a behavior of browsing a news article, posted information, or the like, and input information to the generation model.

The advertisement information 42 is information on an advertisement.

FIG. 5 is a diagram illustrating an example of the advertisement information 42. As illustrated in FIG. 5, the advertisement information 42 includes items such as an “advertisement ID”, an “advertiser ID”, and “content information”.

The “advertisement ID” is identification information for identifying an advertisement. The “advertiser ID” is identification information for identifying an advertiser. The “content information” is information that indicates a content of an advertisement.

Each of functions (the placement procedure unit 31, the receiving unit 32, the generation unit 33, and the providing unit 34) of the control unit 3 of the information processing apparatus 1 will be described below.

The placement procedure unit 31 carries out an advertisement placement procedure. Firstly, the placement procedure unit 31 receives an advertisement distribution request from the advertiser terminal 200. The distribution request includes, for example, information on an advertising target product, an advertisement content (release of a new product, a sale to be held, or the like), a distribution target, an advertising budget, or the like.

The placement procedure unit 31 when receiving the distribution request, vectorizes a main intention of the advertisement based on information that is included in the distribution request. For vectorization, for example, a well-known vectorization method, such as Word to Vector, is used. Further, the placement procedure unit 31 determines an advertisement content, such as a situation in which the advertisement is published (a condition for a search query or the like) or a circumstance (a location of an advertisement area to be displayed or the like) based on the generated vector, and generates the advertisement based on the determined advertisement content. Furthermore, the placement procedure unit 31 transmits the generated advertisement to the advertiser terminal 200, and makes a request to an advertiser for permission to publish the advertisement. When receiving a request for re-generation of an advertisement, the placement procedure unit 31 acquires information on a portion to be modified, performs vectorization again, and re-generates an advertisement.

The receiving unit 32 receives various kinds of information. The receiving unit 32 receives an advertisement generation request including advertisement content information from the user terminal 100.

The generation unit 33 generates an advertisement content based on the advertisement generation request. In the advertisement placement procedure, the generation unit 33 selects an advertisement in which the advertisement content included in the advertisement generation request is adopted as a selling point, and generates the advertisement as the advertisement content. When a plurality of advertisements are selected, the generation unit 33 generates, as the advertisement content, an advertisement for which an advertising cost per unit is highest based on a bidding system.

The providing unit 34 provides the generated advertisement content to the user terminal 100.

A configuration example of the user terminal 100 will be described below with reference to FIG. 6.

FIG. 6 is a diagram illustrating a configuration example of the user terminal 100 according to one embodiment. As illustrated in FIG. 6, the user terminal 100 includes a communication unit 110, a control unit 120, and a storage unit 130. The control unit 120 includes an acquisition unit 121, an identification unit 122, a generation unit 123, and a display processing unit 124.

The communication unit 110 is implemented by, for example, an NIC or the like. The communication unit 110 is connected to a network in a wired or wireless manner.

The control unit 120 is a controller and implemented by causing a processor, such as a CPU or an MPU, to execute various kinds of programs (corresponding to an example of the information processing program) that are stored in a storage device inside the user terminal 100 by using a RAM or the like as a work area. Further, the control unit 120 is a controller and may be implemented by, for example, an integrated circuit, such as an ASIC, an FPGA, or a GPGPU.

The storage unit 130 is implemented by, for example, a semiconductor memory device, such as a RAM or a flash memory, or a storage device, such as a hard disk or an optical disk.

Each of functions (the acquisition unit 121, the identification unit 122, the generation unit 123, and the display processing unit 124) of the control unit 120 of the user terminal 100 will be described below.

The acquisition unit 121 acquires various kinds of information. The acquisition unit 121 acquires input information to a predetermined generation model. The generation model acquires, as the input information, a prompt (that is, a search query) for a generation model that generates a search result. Meanwhile, the generation model is not limited to the generation model that generates a search result, but may be an arbitrary generation model. Further, the input information may be information of various kinds of forms, such as a text, an image, or a voice.

The identification unit 122 identifies, based on the input information, product information that is estimated to be selected by the user. The identification unit 122 stores therein a model (agent) that is trained to output product information from the input information. The model is a model that is trained with, for example, past input information and a behavior (a behavior of selecting a product or the like) that was made by the user after input of the input information. For example, the identification unit 122 generates a model that is trained with a behavior of leading to conversion with respect to an advertisement displayed in a search result screen, a behavior of browsing product information displayed in the search result screen, and a behavior of purchasing a product, which were made when the user inputted a predetermined search query in the past. In other words, the identification unit 122 inputs the input information to the model and identifies the product information that is estimated to be selected by the user based on a behavior (a behavior of selecting a product) that is output from the model. The product information includes, for example, a name, a type, a price, a function, or the like of a product.

Further, when identifying the product information, the identification unit 122 may additionally take into account the user information. In other words, the identification unit 122 identifies the product information based on the input information and the user information. For example, the user information includes an action history of the user, and the identification unit 122 identifies the product information based on the input information and the action history of the user. For example, the action history includes a browsing history on a network, and when the user recently viewed a site related to specific product information and when the input information and the specific product information are related to each other, the identification unit 122 adopts the specific product information as an identification result.

The generation unit 123 generates advertisement content information that indicates an advertisement content based on the identified product information. For example, when the product information includes a name of a product, the generation unit 123 generates the advertisement content information with the advertisement content including the name of the product. Further, for example, when the product information includes a function of a product (for example, an air cleaning function), the generation unit 123 generates the advertisement content information with the advertisement content including the function.

The display processing unit 124 displays the advertisement content. The display processing unit 124 displays an advertisement content that is acquired from the information processing apparatus 1 and an output result of the generation model with respect to the input information.

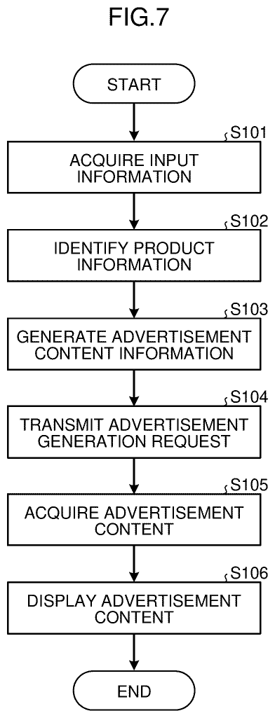

A flow of a process performed by the user terminal 100 according to one embodiment will be described below with reference to FIG. 7. FIG. 7 is a flowchart illustrating the flow of the process performed by the user terminal 100 according to one embodiment.

As illustrated in FIG. 7, firstly, the control unit 120 acquires the input information (Step S101).

Subsequently, the control unit 120 identifies, based on the input information, product information that is estimated to be selected by a user (Step S102).

Then, the control unit 120 generates advertisement content information that indicates an advertisement content based on the identified product information (Step S103).

Subsequently, the control unit 120 transmits an advertisement generation request including the advertisement content information to the information processing apparatus 1 (Step S104).

Then, the control unit 120 acquires the advertisement content from the information processing apparatus 1 (Step S105), displays the advertisement content on the user terminal 100 (Step S106), and terminates the process.

### Others

Of the processes described in the embodiments above, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

For example, a part or whole of the storage unit 4 illustrated in FIG. 3 may be stored in a storage server or the like, instead of being stored in each of the apparatuses. In this case, each of the apparatuses accesses the storage server and acquires various kinds of information.

### Hardware Configuration

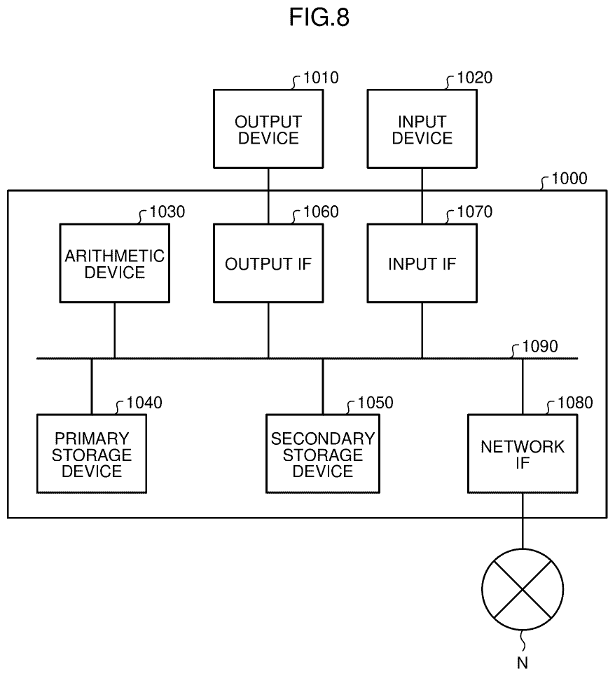

The information processing apparatus 1 and the user terminal 100 according to one embodiment as described above are implemented by, for example, a computer 1000 that is configured as illustrated in FIG. 8. FIG. 8 is a diagram illustrating an example of a hardware configuration. The computer 1000 is connected to an output device 1010 and an input device 1020, and an arithmetic device 1030, a primary storage device 1040, a secondary storage device 1050, an output Interface (IF) 1060, an input IF 1070, and a network IF 1080 are connected to one another via a bus 1090.

The arithmetic device 1030 operates based on a program that is stored in the primary storage device 1040 or the secondary storage device 1050, a program that is read from the input device 1020, or the like, and performs various kinds of processes. The primary storage device 1040 is a memory device, such as a RAM, that temporarily stores therein data that is used by the arithmetic device 1030 for various kinds of calculations. Further, the secondary storage device 1050 is a storage device in which data that is used by the arithmetic device 1030 for various kinds of calculations or various kinds of databases are registered, and is implemented by a Read Only Memory (ROM), a Hard Disk Drive (HDD), a flash memory, or the like.

The output IF 1060 is an interface for transmitting output target information to the output device 1010, such as a monitor or a printer, that outputs various kinds of information, and is implemented by, for example, a connector based on a certain standard, such as a Universal Serial Bus (USB), Digital Visual Interface (DVI), or High Definition Multimedia Interface (HDMI) (registered trademark). Further, the input IF 1070 is an interface for receiving information from various kinds of the input devices 1020, such as a mouse, a keyboard, and a scanner, and is implemented by, for example, a USB or the like.

Meanwhile, the input device 1020 may be a device that reads information from, for example, an optical recording medium, such as a Compact Disc (CD), a Digital Versatile Disc (DVD), or a Phase change rewritable Disk (PD), a magneto-optical recording medium, such as a Magneto-Optical disk (MO), a tape medium, a magnetic recording medium, a semiconductor memory, or the like. Further, the input device 1020 may be an external storage medium, such as a USB memory.

The network IF 1080 receives data from a different apparatus via the network N, sends the data to the arithmetic device 1030, and transmits data generated by the arithmetic device 1030 to a different apparatus via the network N.

The arithmetic device 1030 controls the output device 1010 and the input device 1020 via the output IF 1060 and the input IF 1070. For example, the arithmetic device 1030 loads a program from the input device 1020 or the secondary storage device 1050 onto the primary storage device 1040, and executes the loaded program.

For example, when the computer 1000 functions as the information processing apparatus 1 or the user terminal 100, the arithmetic device 1030 of the computer 1000 executes a program that is loaded on the primary storage device 1040, and implements the functions of the control unit 3 or the control unit 120.

### Effects

As described above, a control program according to one embodiment causes a terminal apparatus (the user terminal 100) to perform an acquisition step of acquiring input information that is input to a predetermined generation model by a user, an identification step of identifying, based on the input information, product information that is estimated to be selected by the user, a generation step of generating advertisement content information that indicates an advertisement content based on the identified product information, and a display processing step of transmitting an advertisement generation request including the advertisement content information to the information processing apparatus 1, acquiring an advertisement content based on the advertisement content information from the information processing apparatus 1, and displaying the advertisement content.

With this configuration, it is possible to improve advertisement distribution efficiency.

Thus, some embodiments of the present application have been described in detail above based on the drawings, but the embodiments are described by way of example, and the present invention may be embodied in various different modes with various modifications and improvement based on knowledge of a person skilled in the art, in addition to the embodiments described in the section of the disclosure of the invention.

### Others

Of the processes described in the embodiments above, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in each of the drawings are not limited to the information illustrated in the drawings.

Furthermore, the components of the apparatuses illustrated in the drawings are functionally conceptual and do not necessarily have to be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions.

Moreover, the processes explained in the embodiments described above may be appropriately combined as long as processing contents do not conflict with each other.

In addition, the “unit (section, module, unit)” described above may be replaced with a “means”, a “circuit”, or the like. For example, the control unit 3 may be replaced with a control means or a control circuit.

According to one aspect of embodiments, it is possible to improve advertisement distribution efficiency.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A non-transitory computer readable storage medium having stored therein a control program that causes a computer to execute a process, the process comprising:
acquiring input information that is input to a predetermined generation model by a user;
identifying, based on the input information, product information that is estimated to be selected by the user;
generating advertisement content information that indicates an advertisement content based on the identified product information;
transmitting an advertisement generation request including the advertisement content information to the information processing apparatus;
acquiring an advertisement content based on the advertisement content information from the information processing apparatus; and
displaying the advertisement content.

2. The computer readable storage medium according to claim 1, wherein
the predetermined generation model is a model that outputs a search result based on a search query that is input by the user, and
the acquiring includes acquiring the search result as the input information.

3. The computer readable storage medium according to claim 2, wherein the identifying includes predicting a behavior of the user with respect to the search result, and identifying the product information based on the predicted behavior.

4. The computer readable storage medium according to claim 1, wherein the advertisement content includes at least one of a name, a type, a price, and a function of a product.

5. The computer readable storage medium according to claim 4, wherein the identifying includes identifying the product information based on the input information and user information on the user.

6. The computer readable storage medium according to claim 5, wherein the user information includes an action history of the user.

7. A control method that is implemented by a terminal apparatus, the control method comprising:
acquiring input information that is input to a predetermined generation model by a user;
identifying, based on the input information, product information that is estimated to be selected by the user;
generating advertisement content information that indicates an advertisement content based on the identified product information;
transmitting an advertisement generation request including the advertisement content information to the information processing apparatus;
acquiring an advertisement content based on the advertisement content information from the information processing apparatus; and
displaying the advertisement content.

8. A terminal apparatus comprising:
an acquisition unit that acquires input information that is input to a predetermined generation model by a user;
an identification unit that identifies, based on the input information, product information that is estimated to be selected by the user;
a generation unit that generates advertisement content information that indicates an advertisement content based on the identified product information; and
a display processing unit that transmits an advertisement generation request including the advertisement content information to the information processing apparatus, acquires an advertisement content based on the advertisement content information from the information processing apparatus, and displays the advertisement content.
